(19) United States
(12) Patent Application Publication
(10) Pub. No.: US 2002/0097932 A1
(43) Pub. Date: Jul. 25, 2002

(54) Spherical bearing

(76) Inventors: Douglas Roberts, Ellington, CT (US); Jeff Murray, Ellington, CT (US)

Correspondence Address: KEITH MURPHY, Cantor Colburn LLP, 55 Griffin Road South, Bloomfield, CT, 06002, US

(21) Appl. No.: 10/000,788

(22) Filed: Oct. 31, 2001

Related U.S. Application Data
(60) Provisional application No. 60/244,727, filed on Oct. 31, 2000.

(51) Int. Cl. F16C 32/06

(52) U.S. Cl. 384/108

(57) ABSTRACT

A spherical bearing includes a spherical member connected to another member where the spherical member is further received in a retainer configured to retain the spherical member and allow movement thereof.

### CROSS REFERENCE TO RELATED APPLICATIONS

This application claims the benefit of an earlier filing date from U.S. Provisional Application Serial No. 60/244,727 filed Oct. 31, 2000, the entire disclosure of which is incorporated herein by reference.

### TECHNICAL FIELD

This disclosure relates to spherical bearings, and, more particularly, to a ball joint that is adjustable for wear, can be maintained with minimal lubrication, and is dimensioned to have a low profile design that allows a multitude of such ball joints to operate in close proximity to each other.

### BACKGROUND

The ability of a bearing to perform in a given application depends generally on a combination of factors such as the operating environment, which includes the temperature of the bearing and amount and type of lubrication on the bearing and its mating surfaces, the load or pressure on the bearing surfaces, the sliding velocity of the mating surfaces relative to the bearing, the hardness and finish of the mating surface, the frictional behavior of the bearing material, and the thickness of the bearing material combined with the ability of the bearing material to dissipate heat generated as a result of friction.

In a typical prior art bearing, a run-in time is generally required in which the bearing is “adjusted” under operating conditions for the load exerted on the parts and the velocity of the parts relative to each other in order to acclimate the bearing to the operating environment. Subsequent to this run-in time, a burnishing effect takes place with respect to the bearing and mating surfaces that results in undesirable clearances being formed between the bearing and mating surfaces. This formation of clearances is typically countered by preloading the bearing after manufacture and prior to assembly of the system into which the bearing is to be installed. The unpredictability of the combination of factors giving rise to the ability of the bearing to adequately perform, however, generally precludes easy modification of the bearing and often results in the manufacture of a bearing in which manufacturing tolerances are over- or under-compensated for, thereby resulting in a bearing that wears excessively or otherwise performs inadequately.

### SUMMARY

An spherical bearing in which the problems associated with the bearings of the prior art are alleviated or eliminated is disclosed herein. The spherical bearing includes a stud that is substantially spherical and is connectable to a first support member, a retainer connectable to a second support member, and a bearing insert disposed within the retainer. The retainer is configured and dimensioned to accommodate the stud therein and to allow the stud to be rotatably translated. The bearing insert is configured to engage the stud from a direction that is coaxial with a force exerted on the stud along a longitudinal axis of the retainer. In a preferred embodiment, the bearing insert has a concave spherical surface that is dimensioned to receive the rounded surface of the stud. A socket may be connected to the retainer to retain the stud in the retainer. The stud may be in mechanical communication with a resilient member mounted on the second support member.

In order to spring load the spherical bearing, a stud being fixedly connectable to a support member is received in a mounting surface and a resilient member is disposed between the stud and the mounting surface to provide flexible communication between the stud and the mounting surface. The stud is typically held in flexible communication with the mounting surface using a retaining plate. In a preferred embodiment, the resilient member is a wave spring.

The operability of a system that incorporates the spherical bearing is optimized by the arrangement of the bearing insert such that a force exerted on the bearing in the direction of the stud is directly (as opposed to tangentially) opposed by the bearing insert and is substantially equally distributed over the concave surface thereof. Such an arrangement avoids the slipping and wedging often associated with bearings of the prior art in which bearing inserts are arranged laterally around the stud. In the herein described spherical bearing, the run-in period may also be eliminated or at least minimized due to the incorporation of a spring system that ensures a predictable and constant preload on the bearing and takes up any clearance between the bearing and mating surfaces due to wear. Assembly of the bearing is simplified by the minimization of the number of parts of the bearing, which in turn makes the bearing relatively inexpensive to produce. Simple assembly of the bearing also facilitates the efficient assembly of a strut system into which the bearing is incorporable.

The strut system, in turn, is incorporable into an apparatus for performing work operations on a surface of a lens. Such an apparatus includes a frame, a lens finishing surface, a carriage for supporting a lens blank, and the struts of the strut system providing communication between the carriage and the frame through the spherical bearings. Movement of the struts through the spherical bearings effectuates the finishing of the lens blank to a desired finish.

### BRIEF DESCRIPTION OF THE DRAWINGS

FIG. 1 is an exploded isometric view of an spherical bearing.

FIG. 2 is a side elevation view of a plug.

FIG. 3 is a cross-sectional view of a retainer.

FIG. 4 is a cross-sectional view of an insert washer.

FIG. 5 is a side elevation view of a stud.

FIG. 6 is a cross-sectional view of a bearing insert.

FIG. 7 is a cross-sectional view of a socket.

FIG. 8 is a partially exploded side view of a strut assembly incorporating two spherical bearings.

FIG. 9 is a side elevation view of a strut.

FIG. 10 is a cross-sectional view of an alternate embodiment of a bearing assembly illustrating the operation of the bearing assembly.

FIGS. 11A through 11C are cross sectional views of alternate embodiments of a bearing assembly incorporating spring means by which spherical bearings can be released if overstress conditions occur.

FIG. 12A is a perspective cutaway view of an alternate embodiment of an spherical bearing.

FIGS. 12B through 12E are various perspective, side elevation, and plan views of a retainer of an alternate embodiment of the spherical bearing.

FIG. 13 is a perspective view of a carriage into which an alternate embodiment of an spherical bearing can be incorporated.

FIGS. 14A and 14B are cross sectional views of an alternate embodiment of spherical bearings incorporated into a strut assembly and showing the strut assembly in various positions.

FIG. 15 is a perspective view of an apparatus for performing work operations on a surface of a lens that incorporates the spherical bearings.

FIGS. 16A through 16D are various perspective, side elevation, and plan views of a mounting bracket.

FIG. 17 is a perspective view of an alternate strut.

FIG. 18 is an exploded cross sectional view of an alternate strut.

FIG. 19 is a cross sectional view of the alternate strut.

### DETAILED DESCRIPTION

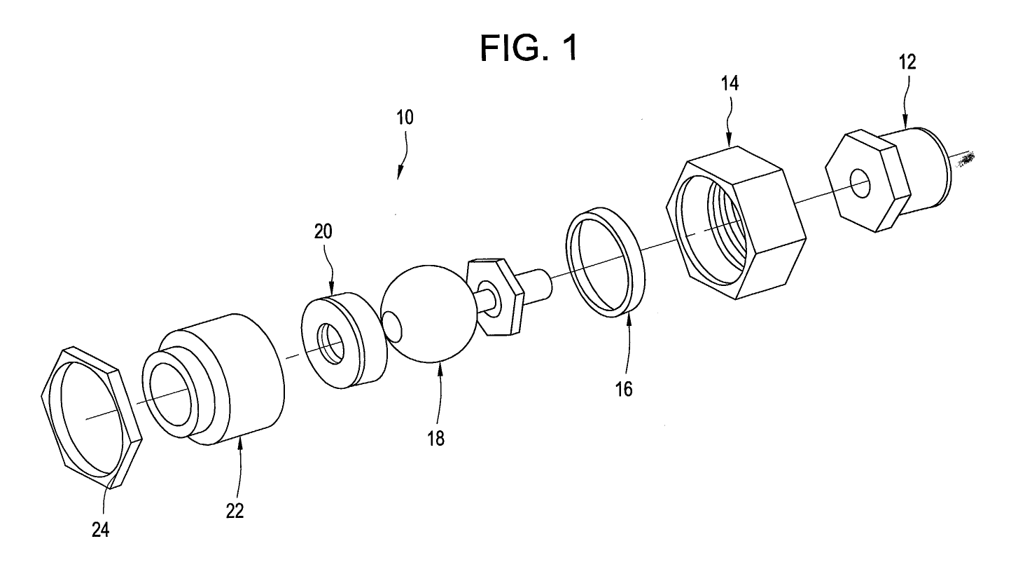

Referring now to FIG. 1, an spherical bearing is shown generally at 10 and is hereinafter referred to as “bearing 10”. Bearing 10 comprises a plug, shown generally at 12, a retainer, shown generally at 14, an insert washer, shown generally at 16, a stud, shown generally at 18, a bearing insert, shown generally at 20, a socket, shown generally at 22, and a nut jam 24. Bearing 10 is mountable in various configurations to provide support for a variety of different applications.

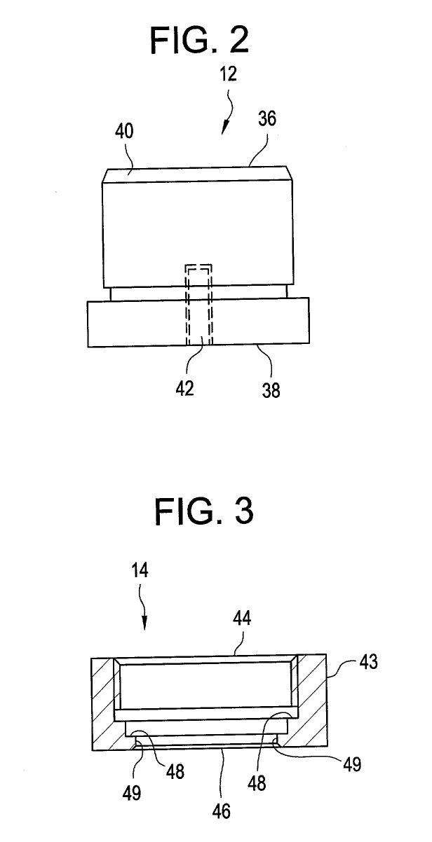

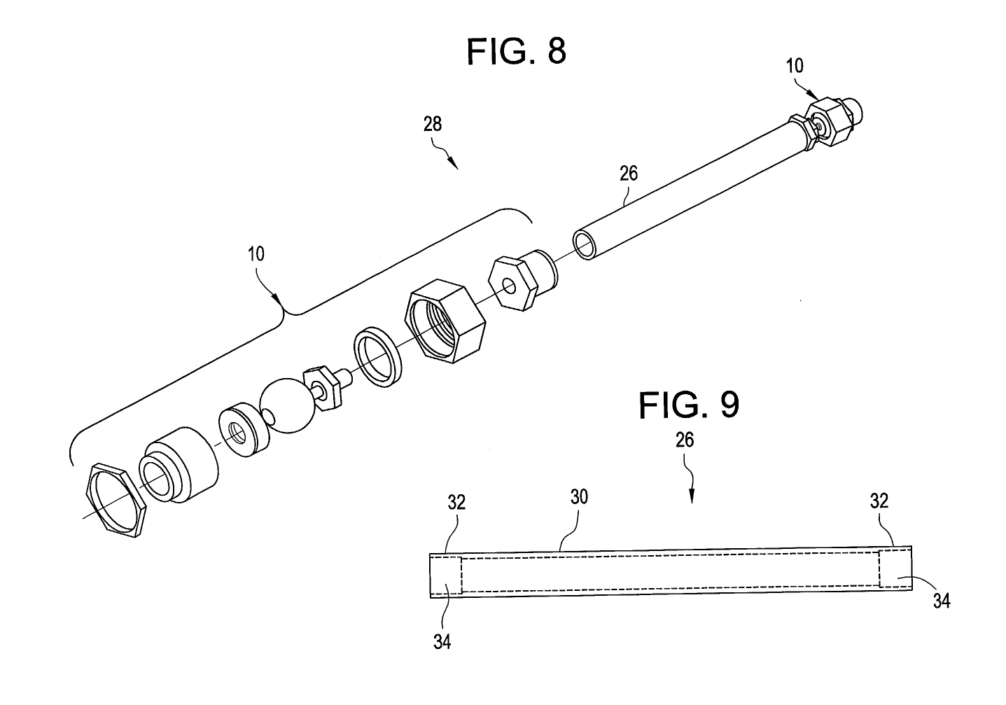

In FIG. 2, plug 12 is shown. Plug 12 comprises an insert end 36 and a base end 38 and is mountable in a hole in a surface (not shown) by causing insert end 36 to be received in the hole and frictionally retained therein, thereby leaving base end 38 to project from the hole. Insert end 36 is typically of a circularly shaped cross section, although other geometries may be utilized. Insert end 36 is generally of a substantially smaller diameter than base end 38 is in order to prevent plug 12 from being inserted too deeply into the hole into which plug 12 is inserted. Insert end 36 also includes a chamfered surface 40 disposed therearound to facilitate the insertion of plug 12 into the hole. The hole may be positioned in a strut assembly (as will be described below with reference to FIGS. 8 and 9) or a similar configuration.

In a preferred embodiment, the cross section of base end 38 of plug 12 is hexagonally shaped. Other geometries that may be utilized for the cross section of base end 38 include, but are not limited to, square, round, octagonal, or multi-toothed geometries. A hole 42 is bored or drilled into base end 38 and tapped to enable the stud (shown below with reference to FIG. 5) to be threadedly received therein for secure mounting of the bearing. Plug 12 is typically fabricated from aluminum and typically has a sulfuric anodized finish.

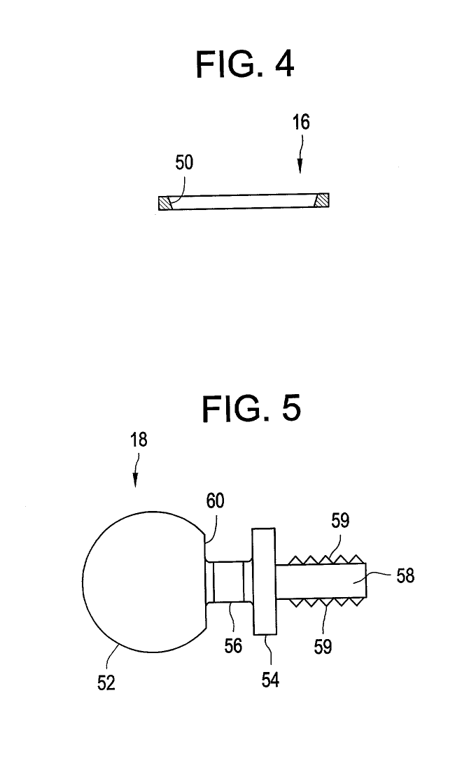

Referring to FIG. 3, the retainer is shown at 14. Retainer 14 comprises a housing 43 of a hexagonally shaped outer cross section and is typically fabricated of aluminum. Housing 43 has a first open end 44 and an opposing second open end 46, thereby defining a bore that extends through housing 43. The bore is dimensioned and configured to receive the insert washer (shown below with reference to FIG. 4) and to receive and house the stud therein. A surface 48 is perpendicularly formed relative to the defining surface of the bore and extends circumferentially around the defining surface of the bore to provide a surface upon which the insert washer can be adjacently positioned. An edge surface 49 proximate second open end 46 of housing 43 is configured to engage the base end of the plug.

FIG. 4 illustrates insert washer 16, which is a ring having an inner surface that defines a chamfered surface 50. Insert washer 16 is dimensioned and configured to be seated on the surface within the bore of the retainer, as described above. Chamfered surface 50 provides a surface against which a rounded outer surface of the stud can rest. In a preferred embodiment, insert washer 16 is fabricated from aluminum.

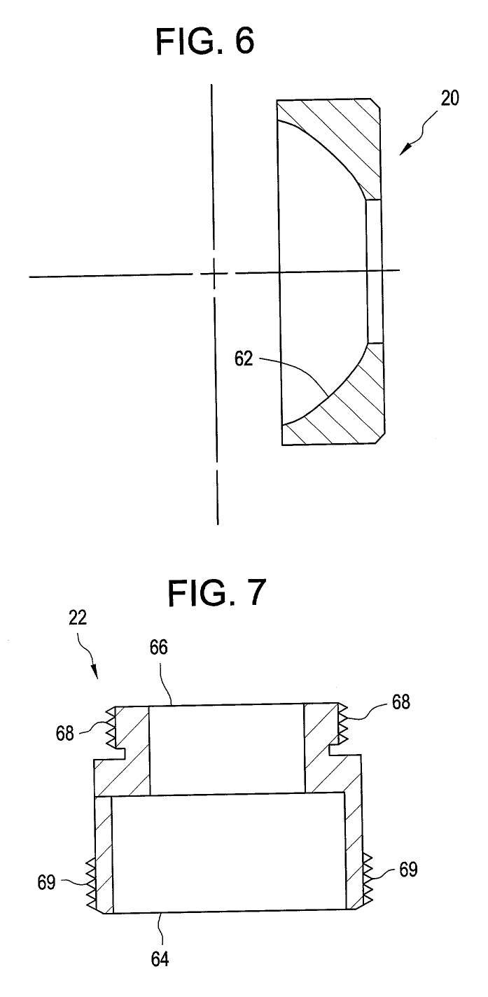

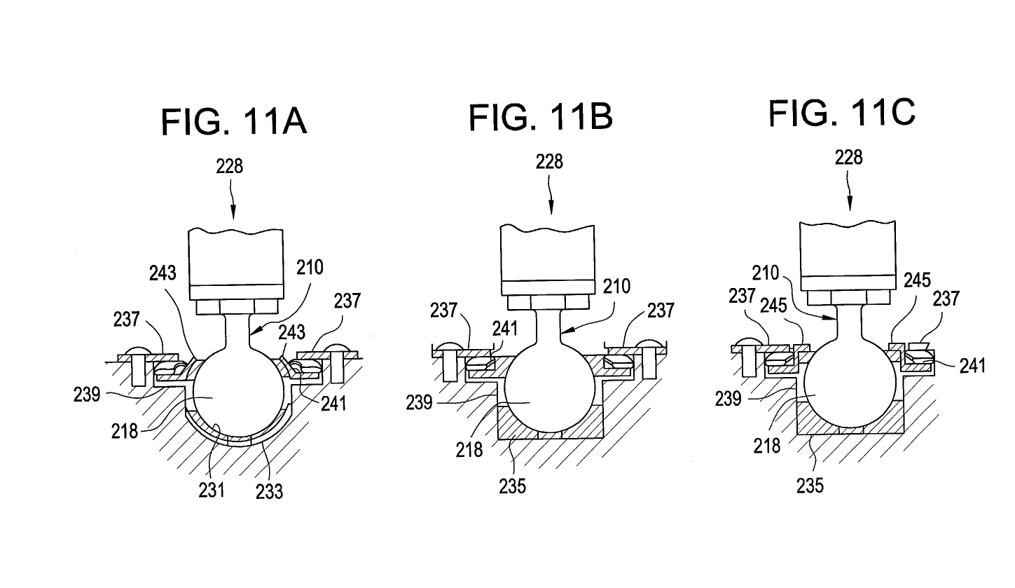

Referring to FIG. 5, stud is shown generally at 18. Stud 18 comprises a ball 52, a base 54, a collar 56 connecting ball 52 to one side of base 54, and a pin 58 extending from an opposing side of base 54. Ball 52 may have a flat surface 60 disposed on a side thereof in order to provide a point of connection for collar 56. Alternatively, as shown below in FIGS. 11A through 11C, the ball may be substantially round. Pin 58 includes a pin thread 59 to enable stud 18 to be threadedly received in the hole in the plug. In a preferred embodiment, ball 52 is stainless steel and is ground, as opposed to being turned, in order to more effectively engage the bearing insert (described below with reference to FIG. 6).

In other embodiments of stud 18, a coating having a low coefficient of friction may be used as an alternative to the stainless steel. The coating may be a polyimide, polytetrafluoroethylene, or a mesh structure fabricated of metal having polytetrafluoroethylene disposed in the voids of the mesh structure. A typical polyimide material suitable for use in the manufacture of stud 18 is DELRIN AFTM, which is commercially available from numerous sources. The metal used for the construction of the mesh may be stainless steel or a similar material. In any embodiment, ball 52 of stud 18 should be fabricated from or at least coated with a material having a coefficient of friction that is low enough to enable stud 18 to translate rotatably within the retainer and the socket without its motion being frictionally impeded. Furthermore, the material of fabrication should be such that the difference between the static and dynamic coefficients of friction is minimal. Preferably, this difference should be less than about 0.05.

The stud is engaged by bearing insert, shown generally at 20 in FIG. 6. Bearing insert 20 is configured and dimensioned to receive the rounded surface of the ball of the stud opposite the collar of the stud. A concave spherical surface 62 is disposed on an inner portion of bearing insert 20 and is dimensioned to mate with the rounded surface of the ball. Bearing insert 20 is arranged such that a force exerted on the bearing in the direction of the stud and coaxial with a longitudinal axis of the bearing is substantially uniformly distributed over concave spherical surface 62 (i.e., concave spherical surface 62 is substantially perpendicular to the direction of force exerted on the stud). Such an arrangement enables a force exerted on the stud in the direction of the ball to be uniformly absorbed by concave spherical surface 62 of bearing insert 20, thereby avoiding the tendency of the stud to wedge between the bearing inserts of a configuration in which bearing inserts engage a stud from its sides, as is characteristic of prior art systems. Bearing insert 20 is preferably fabricated from polyimide material.

Referring to FIG. 7, the socket for receiving the bearing insert is shown at 22. Socket 22 is configured and dimensioned to receive the bearing insert and to frictionally retain the bearing insert therein. Socket 22 comprises a receiving end 64 and an anchor end 66. Receiving end 64 has an opening therein that has a cross section that substantially matches the cross section of the bearing insert in order to facilitate the retaining of the bearing insert. Anchor end 66 includes pin threads 68 disposed thereon to facilitate the anchoring of socket 22 to a surface (not shown) upon which the bearing is mounted using the nut jam (shown at 24 with reference to FIG. 1). Receiving end 64 includes pin threads 69 disposed thereon in order to facilitate the attachment of socket 22 to the retainer (shown at 14 with reference to FIG. 3). In a preferred embodiment, socket 22 is fabricated from aluminum, and the nut is fabricated from stainless steel.

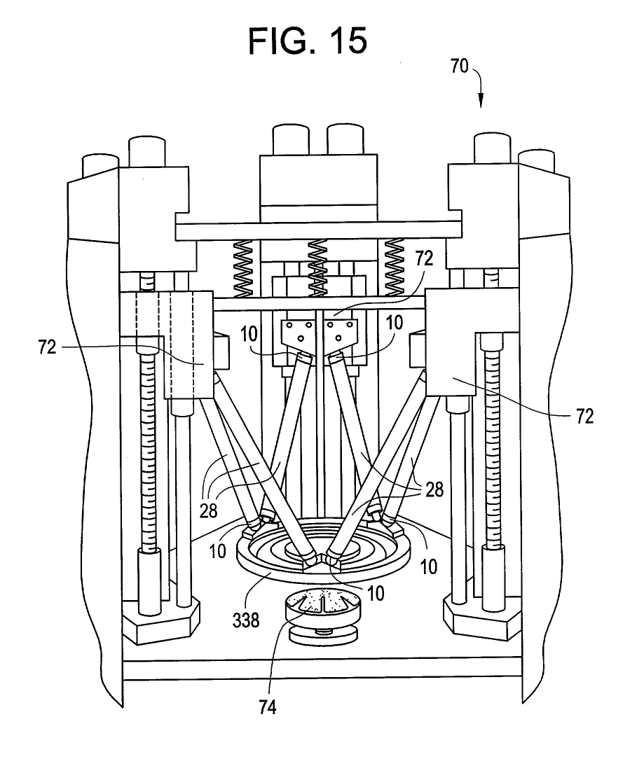

The bearing is mountable in a wide variety of surfaces to accommodate a wide range of applications. Referring to FIGS. 8 and 9, bearing 10 is shown mounted in a strut 26 to form a strut assembly, shown generally at 28. Strut assembly 28 may be a strut used in an apparatus for performing work operations on a surface of a lens, such as that shown below with reference to FIG. 15 and commercially available from Gerber Coburn, of South Windsor, Conn., and sold under the trade name HEXAPOD. Strut 26 is typically a cylindrically shaped element having a body portion 30 and end portions 32. In a preferred embodiment, strut 26 is a drawn tube fabricated from aluminum and has a sulfuric anodized finish. Body portion 30, however, may be solid depending upon the requirements of the final application of the bearing. Each end portion 32 includes a hole 34 formed or drilled therein to support the bearing. In a preferred embodiment of strut 26, each hole 34 is configured to receive bearings such that in a finished application, the bearings are coaxially positioned relative to each other and are facing in opposing directions. Each hole 34 is furthermore dimensioned to receive the plug (shown above with reference to FIG. 2) that serves as a base for the bearing.

The bearing must be properly assembled prior to its use. Referring back to FIG. 1, the assembly of bearing 10 is described. In assembling bearing 10, plug 12 must be securely anchored. In a preferred embodiment, insert end 36 of plug 12 is press-fitted into and frictionally retained in a hole, which may be in a strut or some other location. Insert washer 16 is then press-fitted into retainer 14 such that the chamfered surface faces away from plug 12. Bearing insert 20 is then press-fitted into the receiving end of socket 22 such that the concave spherical surface faces outward from the receiving end of socket 22. The threads of the pin of stud 18 are then coated with a solid lubricant in order to facilitate the engagement of the pin of stud 18 with the tapped hole of plug 12. In a preferred embodiment, the solid lubricant is a polytetrafluoroethylene tape. The pin of stud 18 is then passed through retainer 14 having insert washer 16 retained therein and threaded into the hole of plug 12. The entire rounded surface of stud 18 is coated with grease, socket 22 is threaded onto retainer 14, and nut jam 24 is threaded onto the anchor end of socket 22.

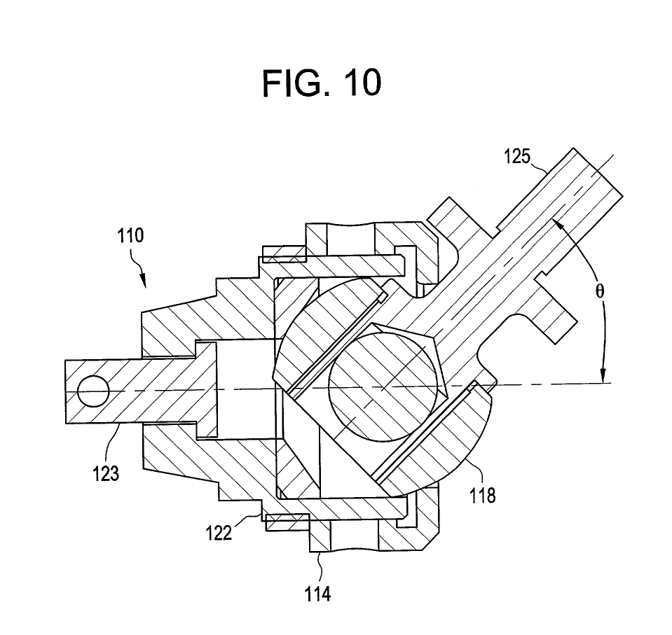

Referring to FIG. 10, the operation of an alternate embodiment of a bearing 110 is shown. A retainer 114 threadedly receives and a socket 122 so as to define a space therebetween in which a stud 118 is loosely accommodated. Socket 122 is mounted to a surface (not shown) using a pin 123. Stud 118 is freely rotatable within retainer 114 and socket 122, thereby enabling an associated member (not shown) attached to a pin end 125 of stud 118 to translate in a limited spherical motion about retainer 114. The translation of stud 118 is typically at an angle θ of about 45° from the centerline of any embodiment of bearing.

In an alternate bearing system, shown generally at 228 in FIGS. 11A through 11C, an alternate embodiment of a bearing, shown generally at 210, may be spring loaded in order to compensate for excessive stress forces imposed on bearing system 228, thereby enabling bearing 210 to “pop out” of the socket without being damaged. A stud 218 of bearing 210 may engage a mesh-backed soft bearing material 231 bonded to a metal substrate 233, as shown in FIG. 11A, or stud 218 may engage a rigid bearing material 235, as shown in FIGS. 11B and 11C. In any embodiment, stud 218 may be retained by a retaining plate 237 fixedly secured to a surface 239 in which stud 218 is mounted. The spring loaded aspect of alternate bearing system 228 may be derived from a wave spring 241 positioned between retaining plate 237 and a surface of stud 218. A dome-shaped flanged washer 243, as shown in FIG. 11A, or a stepped washer 245, as shown in FIG. 11C, may provide the necessary surfaces upon which wave spring 241 rests and exerts a force on stud 218. Retaining plate 237, as well as washers 243, 245, are designed and fabricated to withstand a predetermined amount of loading, an excess amount thereof which will cause retaining plate 237 and washers 243, 245 to fail, thereby allowing stud 218 to be pulled away from surface 239 in order to minimize the damage to bearing system 228.

As illustrated in FIGS. 11A through 11C, a preferred configuration of stud 218 incorporates a full spherical shape. Such a shape enables particulate-laden liquids to be more easily removed from bearing system 228, thereby avoiding contamination of the joint through the buildup of deposits on the flat surface of stud 218 proximate the collar of stud 218.

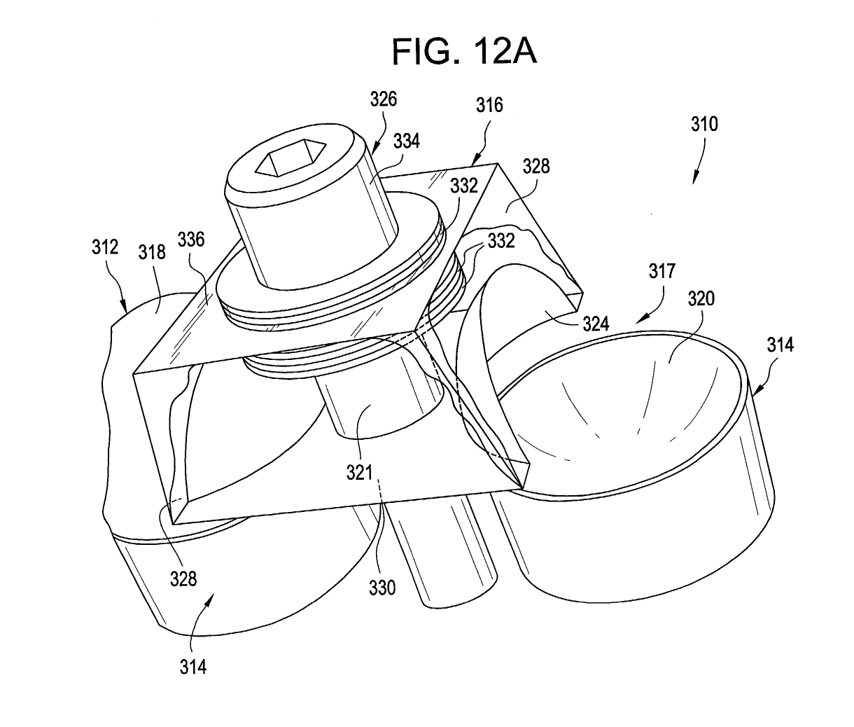

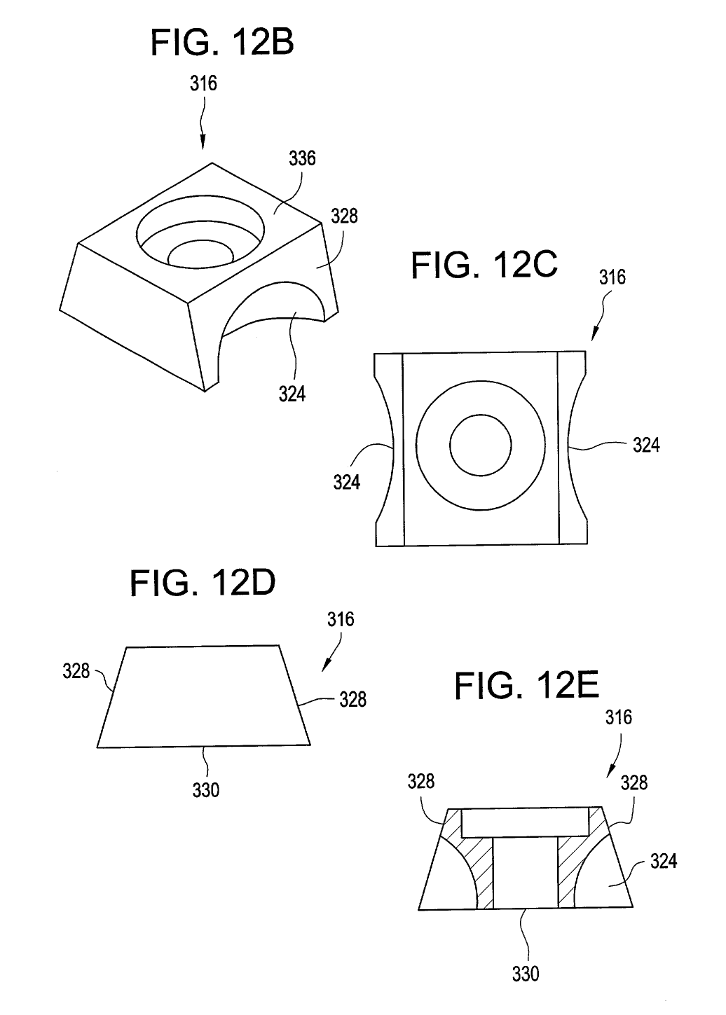

Referring now to FIGS. 12A through 12E, an alternate embodiment of an spherical two ball bearing assembly is shown generally at 310 and is hereinafter referred to as “bearing 310”. Bearing 310 comprises a stud, shown generally at 312, a cup portion, shown generally at 314, and a retainer, shown generally at 316. Although two bearings are ilustrated, each bearing 310 is a separate embodiment. A socket for another such stud 312 is illustrated generally at 317. It should be understood that although this illustration includes two sockets for two studs and only one need be used and only one socket need even be available. Each side (in the drawing) functions independently of the other. As in FIG. 1, bearings 310 are mountable in various configurations to provide support for a variety of different applications.

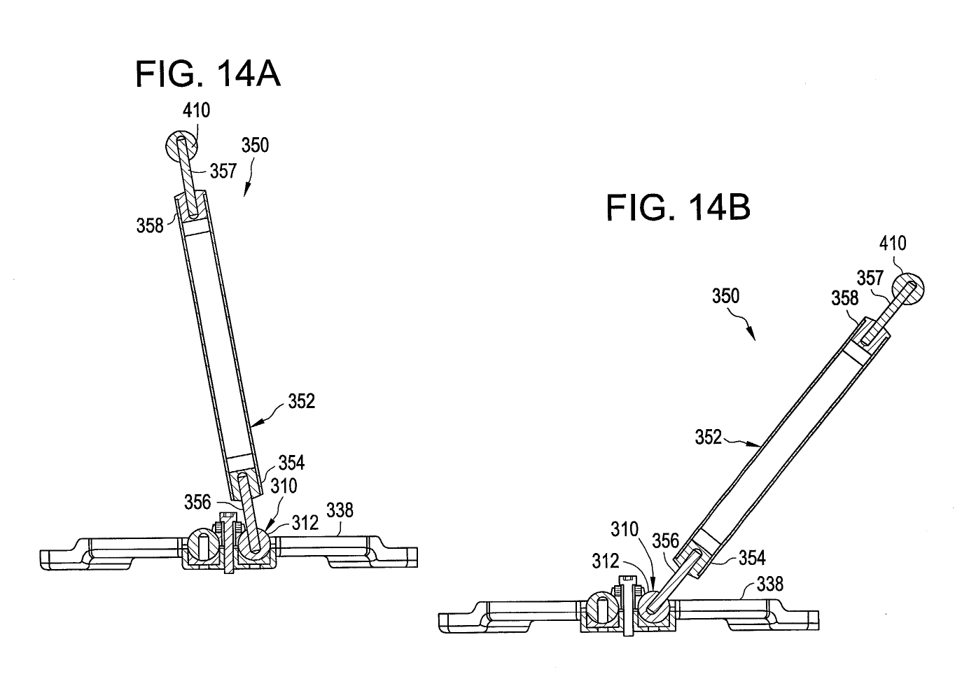

Stud 312 of bearing 310 comprises a ball 318 having a pin (shown below with reference to FIGS. 14A and 14B) extending therefrom. The pin may include a pin thread thereon in order to facilitate the engagement of the pin with a box thread (not shown) formed in a surface or element (not shown) to which bearing 310 is to be mounted. In a preferred embodiment, the pin is pressed onto the surface or element and is retained therein. The pin is connectable to a myriad of different elements, which may include, for example, struts, as will be described below with reference to FIGS. 14A and 14B. Preferably, ball 318 is fabricated from stainless steel and is ground in a manner similar to that of bearing 10 illustrated in FIG. 1. Alternately, ball 318 may include a coating having a low coefficient of friction disposed thereon. Typical coatings include, but are not limited to, polyimides, polytetrafluoroethylenes, or mesh structures fabricated of metal and having polytetrafluoroethylene disposed in the voids thereof.

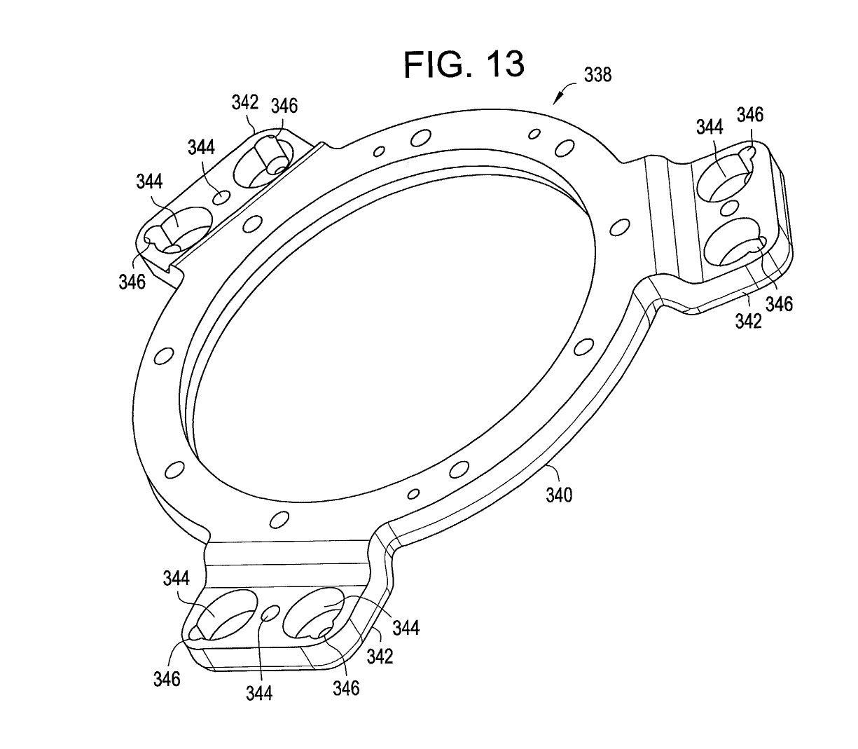

Cup portion 314 comprises a concave spherical surface 320 dimensioned and configured to receive ball 318 of stud 312 therein. Cup portion 314 is fixedly mountable in a surface (not shown) or similar device, as described below with reference to FIG. 13, such that an outer convex surface of ball 318 is intimately engagable with concave spherical surface 320 of cup portion 314 and is in sliding contact therewith. Cup portion 314 is preferably fabricated from a material that is conducive to being formed into the concave spherical shape, such as DELRIN AF™, which is commercially available from numerous sources.

Retainer 316, as can be best seen in FIGS. 12B through 12E, comprises a concave spherical surface 324 dimensioned and configured to receive a portion of the outer convex surface of ball 318. Retainer 316 is flexibly mountable proximate cup portion 314 and is positioned such that concave spherical surface 324 is intimately engagable with the outer convex surface of ball 318 when ball 318 is received in cup portion 314. A bore (not shown) is formed through retainer 316 and a fastener, shown generally at 326, is inserted into a sleeve 321 positioned in the bore, the fastener 326 is secured to carriage 338 (see FIG. 13) in order to retain retainer 316 in its proper position relative to cup portion 314.

As illustrated, (and it will be recalled that although a bilateral symmetry is shown it is not necessarily to be included; each side functions independently of the other) retainer 316 is typically frusto-pyramidical in shape and has two concave spherical surfaces 324 disposed in opposing side surfaces 328 thereof. Opposing side surfaces 328 are angled relative to a base 330 of frusto-pyramidically shaped retainer 316 such that the pin of stud 312 is capable of experiencing a wide range of motion in any direction about retainer 316. In particular, opposing side surfaces 328 of retainer 316 can be angled such that an edge of retainer 316 that defines concave spherical surface 324 can extend (at least partially) over an equator of ball 318 of stud 312 to maintain stud 312 in its proper position and to enable stud 312 to experience a wide range of motion in both lateral and radial directions relative to retainer 316. That is, in order to retain ball 318, the mating surfaces of 324 and 314 together must extend sufficiently around ball 318 to envelope just beyond the largest diameter thereof. This maintains position of ball 318 in a retained condition while allowing the largest degree of freedom of stud 312. Retainer 316 is preferably fabricated from a material that is conducive to being formed into the frusto-pyramidical shape.

Flexible mounting of retainer 316 is achieved by the positioning of resilient members 332 between a head 334 of fastener 326 and an adjacent surface 336 of retainer 316. Resilient members 332 may be spring washers, such as Belleville washers, although other devices including, but not limited to, wave springs can be used. Also, although not shown, resilient members may be positioned between the surface on which retainer 316 is disposed and base 330 of retainer 316. In either configuration, when stud 312 is positioned in cup portion 314 and retained therein with retainer 316, the flexibility of retainer 316 relative to stud 312, which is effectuated by a combination of resilient members 332, allows for stud 312 to be removed from cup portion 314 and retainer 316 in an angularly overstressed condition without causing damage to the componentry of bearing 310 or to a system with which bearing 310 is in communication.

As stated above, each bearing is a separate embodiment. Two bearings (as illustrated) or more may be configured to be mountable in a carriage (shown below with reference to FIG. 13) for use in an apparatus (not shown) in which work operations may be performed on a workpiece.

Referring now to FIG. 13, the carriage in which bearings 310 are mountable is shown generally at 338. Carriage 338 comprises a ringed member 340 upon which a workpiece (not shown) can be secured in such a manner so as to facilitate operations on the workpiece. A plurality of brackets 342 depend radially away from ringed member 340 at points which may be equidistant from each other on an outer surface of ringed member 340. Brackets 342 include holes 344 disposed therein that are dimensioned to receive the cup portions and retainers necessary for the mounting of the bearings. Holes 344 may include notched areas 346 to facilitate removal of cup 314 in the event its removal is desired.

Referring to FIGS. 14A and 14B, a strut assembly is illustrated generally at 350 and in a condition where such strut is connected to carriage 338. The illustrations provide a pictoral view of the strut in two distinct positions relative to carriage 338. These positions are but two of an infinite number of possible positions bounded by the physical constraint of retainer 316 and 314. Each strut assembly comprises a tubular member, end caps and studs (one on each end), the stud comprising a pin and a ball. Struts 352 are rotatably positioned relative to bearings 310 and are, therefore, positionable in a wide variety of configurations due to the sliding contact maintained between studs 312 and retainers 316. First ends 354 of struts 352 may be connected to pins 356 of studs 312, and second ends 358 of struts 352 may be connected to pins 357 which are connected to balls 410.

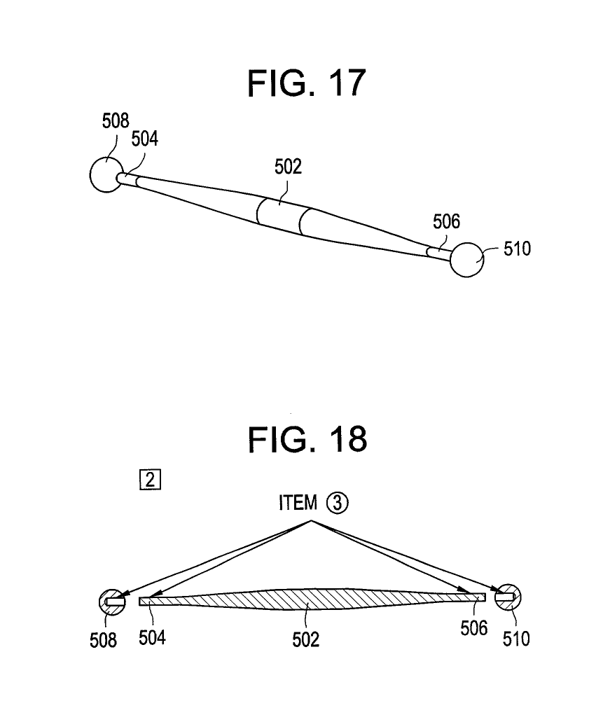

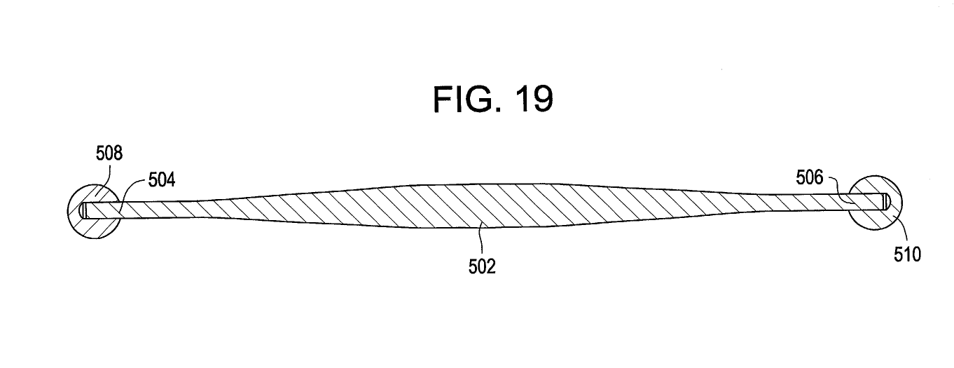

Referring to FIGS. 17-19 an alternate strut is disclosed. While it will be appreciated from the foregoing that strut 350 employs seven components, the following embodiment employs merely three reducing material cost and assembly time. Strut 500 includes an elongated central member 502 tapered at each end 504, 506 to facilitate receipt in (a clearance fit or interference fit) with balls 508, 510 where said member is adheredly retained (for clearance embodiment). Each ball 508, 510 defines a bore from a surface thereof into the interior thereof. Clearance may be provided in the depth of the balls for precision length adjustment of strut 500 during manufacture. It will be understood by one of skill in the art that member 502 and its connected balls 508, 510 may also be retained by other means such as pressfit connection, threaded connection, etc. The balls 508, 510 need merely be restrained reliably so that strut length does not change during the life of the strut. In one embodiment the member 502 is constructed of a lightweight material such as aluminum, plastics may also be employed if durable enough and stiff enough for the particular application. The balls, as in previous embodiments may be stainless steel or other materials including plastics if sufficient for the particular application. In one embodiment, stainless steel balls are treated with a friction reducing component such as commercially available poly-ond (trademark).

As illustrated in FIGS. 17-19 member 502 is of a larger diameter at a central area thereof than at either end. This provides for desirable stiffness in member 502 while transitioning to a diameter that facilitate reception of ends 504, 506 in balls 508, 510. Upon manufacture of each strut, the balls are attached to member 502 with care to ensure that a ball-center-to-ball-center measurement will be consistent for each strut.

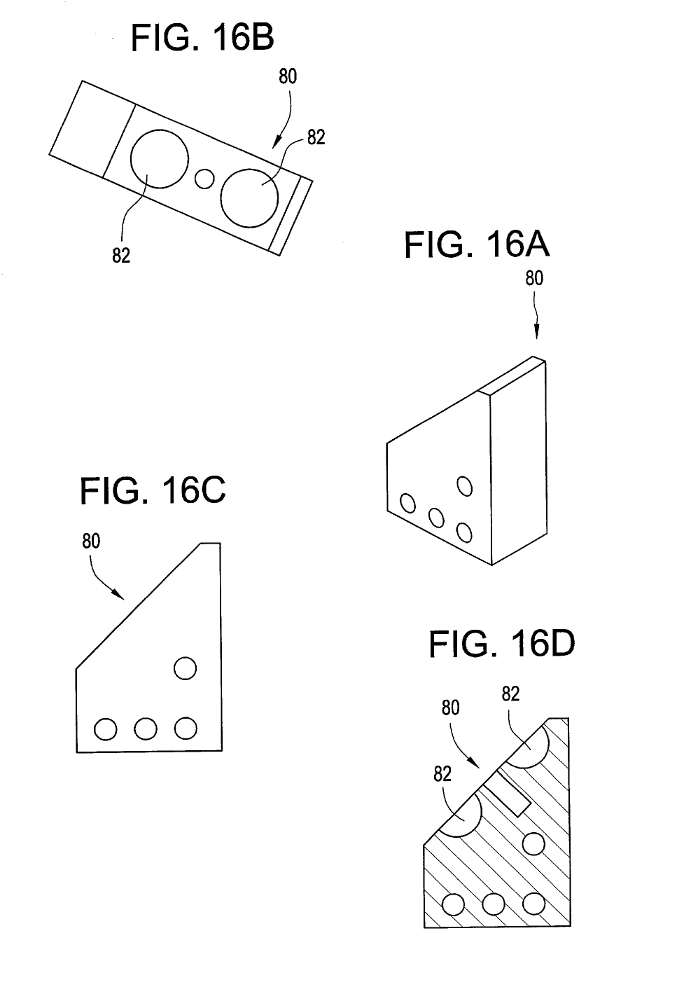

Generally with respect to the spherical bearing embodiments disclosed bearing 10, as well as its alternate embodiments, is incorporable into a strut system for use in an apparatus for performing work operations on a surface of a lens. Such an apparatus is taught in issued U.S. Pat. No. 5,980,360, which is incorporated herein by reference in its entirety. Referring to FIG. 15, the apparatus is shown generally at 70. Apparatus 70 comprises a frame 72, a lens finishing surface 74, carriage 338 for supporting a lens blank (not shown), a plurality of struts 28 positioned between frame 72 and carriage 338, and bearings 10 disposed between the ends of struts 28 and carriage 338 and the ends of struts 28 and frame 72. In FIGS. 16A through 16D, strut mounting brackets 80 are positioned between ends of struts 28 and frame 72 in order to retain struts 28 in their proper positions. Recesses 83 are disposed in mounting brackets 80 to receive bearings 10. Referring back to FIG. 15, in the operation of apparatus 70, struts 28 are moved between raised and lowered positions in response to commands issued from a controller. Apparatus 70 includes a driver (not shown) for causing movement of struts 28 (not shown), which in turn necessitates the movement of carriage 338, and which has the lens blank connected thereto. Movement of carriage 338 causes the lens blank to engage lens finishing surface 74 such that the lens blank is made to correspond with prescribed finish characteristics.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

1. A spherical bearing, comprising:
a stud, said stud being substantially spherical in shape and fixedly connectable to a first support member;
a retainer configured and dimensioned to accommodate said stud therein and allow said stud to be rotatably positioned therein, said retainer being fixedly connectable to a second support member; and
a bearing insert disposed within said retainer, said bearing insert being configured to engage said stud from a direction that is coaxial with a force exerted on said stud along a longitudinal axis of said retainer.

2. The spherical bearing of claim 1 wherein said bearing insert comprises a concave spherical surface, said concave spherical surface being dimensioned to receive and engage a rounded surface of said stud.

3. An spherical bearing, comprising:
a cup portion having a concave surface thereon;
a stud, said stud having a convex surface thereon and being in sliding contact with said concave surface of said cup portion, and said stud being connectable to a support member; and
a retainer positioned adjacent said stud and configured to retain said stud in said cup portion.

4. The spherical bearing of claim 3 wherein said stud is configured to be removable from said cup portion and said retainer under an application of a predetermined amount of stress.

5. The spherical bearing of claim 3 wherein said retainer is flexibly positioned relative to said cup portion.

6. The spherical bearing of claim 5 wherein said retainer includes a fastener extending therethrough, said fastener and said retainer having a resilient member disposed therebetween to facilitate the flexible positioning of said retainer.

7. The spherical bearing of claim 6 wherein said resilient member is a spring washer.

8. A strut assembly, comprising:
a bearing, comprising,
a stud, said stud being substantially spherical in shape,
a retainer configured and dimensioned to accommodate said stud therein and allow said stud to be rotatably positioned therein, said retainer being fixedly connectable to a first support member, and
a bearing insert disposed within said retainer, said bearing insert being configured to engage said stud from a direction that is coaxial with a force exerted on said stud along a longitudinal axis of said retainer; and
a strut, said strut being fixedly connected to said stud of said bearing and fixedly connectable to a second support member.

9. The strut assembly of claim 8 wherein a coefficient of friction of said stud and a coefficient of friction of said bearing insert enable said stud to freely rotate on said bearing insert.

10. The strut assembly of claim 9 wherein said bearing insert comprises a concave spherical surface, said concave spherical surface being dimensioned to receive and engage a rounded surface of said stud.

11. The strut assembly of claim 10 wherein said concave spherical surface is dimensioned to mate with said rounded surface of said stud and to uniformly distribute a force exerted thereon by said stud.

12. The strut assembly of claim 8 wherein said bearing is in mechanical communication with a spring, said resilient member being mounted to said second support member.

13. An apparatus for performing work operations on a surface of a lens, comprising:
a frame;
a carriage configured, positioned, and dimensioned to support a lens blank;
at least one strut positioned between said frame and said carriage, said at least one strut being in communication with said carriage and said frame through a corresponding number of spherical bearings; and
a driver operably connected to said at least one strut for causing movement of said at least one strut relative to said frame.

14. The apparatus of claim 13 wherein said spherical bearing comprises:
a stud, said stud being substantially spherical in shape and connectable to said strut, and
a retainer configured and dimensioned to accommodate said stud therein and allow said stud to be rotatably positioned therein, said retainer being connectable to said frame.

15. The apparatus of claim 14 further comprising a socket, said socket being connected to said retainer to retain said stud in said retainer, and a bearing insert being positioned in said retainer proximate said socket.

16. The apparatus of claim 14 wherein said bearing insert comprises a concave spherical surface, said concave spherical surface being dimensioned to receive and engage a rounded surface of said stud.

17. The apparatus of claim 16 wherein said concave spherical surface is dimensioned to mate with said rounded surface of said stud and to uniformly distribute a force exerted thereon by said stud.

18. The apparatus of claim 14 wherein said spherical bearing is spring loaded.

19. The apparatus of claim 13 wherein said spherical bearing comprises:
a cup portion having a concave surface thereon,
a stud, said stud having a convex surface thereon and being in sliding contact with said concave surface of said cup portion, and said stud being connectable to a support member, and
a retainer positioned adjacent said stud and configured to retain said stud in said cup portion.

20. The apparatus of claim 19 wherein said stud is configured to be removable from said cup portion and said retainer under an application of a selected amount of stress.

21. The apparatus of claim 19 wherein said retainer is flexibly positioned relative to said cup portion.

22. The apparatus of claim 21 wherein said retainer includes a fastener extending therethrough, said fastener and said retainer having a resilient member disposed therebetween to facilitate the flexible positioning of said retainer.

23. The apparatus of claim 22 wherein said resilient member is a spring washer.

24. A strut comprising:
an elongated central member having two ends; and
a ball at each end of said elongated member.

25. A strut as claimed in claim 24 wherein each said ball is spherical and includes an opening therein to receive said elongated central member.

26. A strut as claimed in claim 25 wherein said opening is a clearance opening with respect to said elongated central member.

27. A strut as claimed in claim 26 wherein each said ball and said elongated central member are maintained in a selected condition with adhesive.

28. A strut as claimed in claim 25 wherein said opening is an interference fit with said elongated central member.

29. A strut as claimed in claim 24 wherein said elongated central member is a solid configuration.

30. A strut as claimed in claim 29 wherein said elongated central member is of a wider diameter in the vicinity of its mid section and tapers near each end thereof to a diameter to be received in each said ball.
